(19) United States
(12) Patent Application Publication
(10) Pub. No.: US 2007/0188895 A1
(43) Pub. Date: Aug. 16, 2007

(54) Vibration suppressor, especially used in motor vehicles

(76) Inventor: Rolf Thiel, Stuttgart (DE)

Correspondence Address: Philip R Warn;Warn Hoffmann Miller & Lalone, P O Box 70098, Rochester Hills, MI, 48307, US

(21) Appl. No.: 10/522,837

(22) PCT Filed: Jul. 25, 2003
(86) PCT No.: PCT/DE03/02504

§ 371 Date: Aug. 31, 2005

(30) Foreign Application Priority Data
Aug. 2, 2002 (DE) 102 35 397.2

(51) Int. Cl. G02B 5/08

(52) U.S. Cl. 359/841

(57) ABSTRACT

Oscillating or vibrating components, especially inside rearview mirrors, are provided in motor vehicles. In order to avoid undesirable vibrations of the inside rearview mirror, the mirror housing (3) is reinforced or complex measures need to be taken to secure the mirror housing (3) to the vehicle. The aim of the invention is to at least significantly reduce the amount of vibrations for various components of motor vehicles by using granulate particles (9) as vibration suppression elements which are placed in a recess. The granulate particles (9) make it possible to suppress and attenuate vibrations in a simple manner. The vibration suppressors are advantageously used in inside rearview mirrors in motor vehicles.

For motor vehicles, oscillation attenuators are known which are designed as auxiliary masses suspended from the vehicle resiliently and so as to provide damping. The oscillations of the primary system are absorbed by the oscillation attenuator, that is to say the primary system no longer vibrates and only the attenuator vibrates. Now, oscillating or vibrating components such as the interior rear-view mirror are provided on the motor vehicle. In order to prevent the undesired vibrations of such an interior rear-view mirror, for example, the mirror housing is stiffened or elaborate measures are implemented when fastening the mirror base to the vehicle.

It is an object of the invention to refine the oscillation attenuator according to the generic type so that it can be used with a straightforward design configuration for a very wide variety of components of a vehicle.

In the oscillation attenuator according to the generic type, this object is achieved according to the invention by the characterising features of claim 1.

The oscillation attenuator according to the invention uses granulate particles which are held in a container. Damping of oscillations is also possible with this oscillation attenuator. Straightforward but nevertheless very accurate tuning of the frequencies or oscillations to be damped is possible through the number and/or size and/or material of the granulate particles. The oscillation attenuator/damper according to the invention may be used with interior rear-view mirrors of motor vehicles, for example, in order to reliably avoid the detrimental vibrations of the interior rear-view mirror. The measures employed to date, for example the use of auxiliary masses, stiffening the mirror housing or optimisation at the mirror base for fastening to the vehicle roof, are elaborate and often unsuccessful. By using the oscillation attenuator/damper according to the invention, however, these detrimental vibrations can be readily avoided in a very straightforward way. The use of granulate particles makes it possible to tune the attenuator/damper exactly to the frequency in question. In particular, it is possible to achieve vibration damping over an oscillation frequency band, so that a very broad-band effect is achieved.

Other features of the invention will be found in the other claims, the description and the drawings.

The invention will be explained in more detail with reference to some embodiments represented in the drawings, in which:

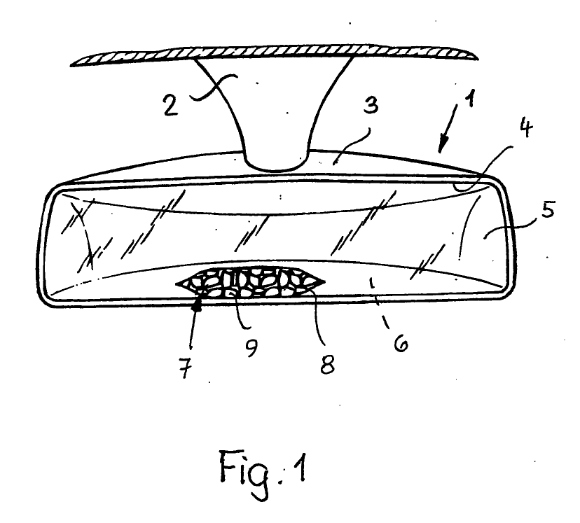

FIG. 1 shows a perspective representation of an interior rear-view mirror of a motor vehicle with an oscillation attenuator according to the invention,

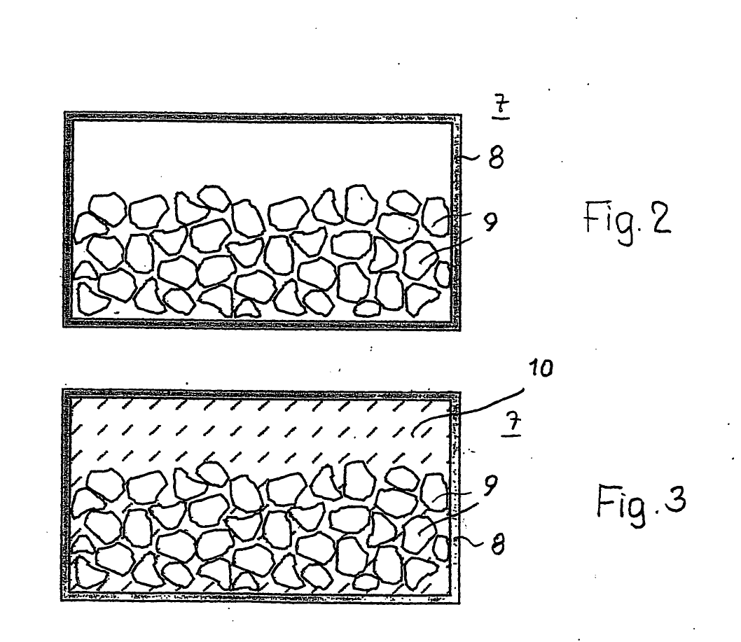

FIG. 2 to FIG. 5 respectively show schematic representations in section of other embodiments of oscillation attenuators/dampers.

The oscillation attenuators and oscillation dampers described below reduce oscillations and vibrations of components. For example, FIG. 1 represents an interior rear-view mirror of a motor vehicle, which is provided with an oscillation attenuator/damper of this kind. It is, however, also possible for exterior rear-view mirrors, cladding elements in the motor vehicle, for example on the roof, planking, spoilers of motor vehicles and the like to be equipped with an oscillation attenuator/damper of this kind.

FIG. 1 shows, for example, an interior rear-view mirror 1 having a mirror base 2 by which the interior rear-view mirror 1 can be fastened to the motor vehicle in a known way. The interior rear-view mirror 1 has a housing 3, which is advantageously adjustable relative to the mirror base 2 in order to be able to adjust the interior rear-view mirror for the driver of the motor vehicle. The housing 3 has an opening 4 facing the driver, in which a mirror glass 5 is arranged.

Together with the mirror glass 5, the housing 3 delimits an interior space in which a very wide variety of components can be fitted. For example, the housing 3 may hold at least one reading light, a background light, a transmitter of a garage opening device, at least one loudspeaker for a radio set inside the motor vehicle or a camera which can be used to observe the driving situation ahead of and/or behind the motor vehicle. These components may be provided selectively on their own in the housing 3 or in any combination with one another.

The mirror glass 5 may be designed as a wedge mirror glass, which can be manually adjusted between a day-time setting and a night-time setting in a known way. The adjustment of the mirror glass 5 may also be motorised. The mirror glass 5 may furthermore be an EC mirror glass, which is automatically darkened in a known way when the mirror glass 5 receives light from a following vehicle. The drive mechanisms and controllers for motorised adjustment or darkening of the mirror glass 5 are advantageously likewise held in the housing 3.

At least one oscillation attenuator/damper 7 is provided on the bottom 6 of the housing 3 and can be fastened on the housing bottom 6, behind the mirror glass 5, in a suitable way.

The oscillation attenuator/damper 7 has a receptacle 8 which is designed to be flexible and, for example, may consist of fabric. The receptacle 8 contains granulate particles 9 which can move freely inside the receptacle 8. The granulate particles have a high density. The granulate particles 9 may, for example, consist of steel which has an appropriately high density. The granulate particles 9 may however also consist of chill-cast iron or malleable cast iron, for example. Chill-cast iron and malleable cast iron have a density of about 7.40 kg/l. The granulate particles have an average diameter of the order of about 3 to 6 mm. The shape of the granulate particles 9 is preferably angulated, although it may also be round.

The granulate particles 9 may consist of different materials, depending on the intended oscillation and vibration damping. For example, plastic particles may be added to granulate particles consisting of steel or cast iron. These plastic particles may consist of polymethyl methacrylate (PMMA), polyamide (PA), styrene-butadiene copolymers or the like. The oscillation and vibration damping can in this way be tuned to the specific case in question, and in particular to the component, by means of an appropriate mixing ratio.

The interior rear-view mirror 1 oscillates or vibrates when driving. The oscillation movement is transmitted to the oscillation attenuator/damper 7 by the housing 3. When the frequency range to be damped is reached and a particular amplitude is exceeded, a relative movement of the granulate particles 9 occurs. The effect of this is that the oscillation energy is converted into movement energy of the granulate particles 9. Friction between the particles occurs owing to the movement of the granulate particles 9 relative to one another, so that sizeable oscillation amplitudes in the relevant resonant range are significantly reduced. The friction between the granulate particles 9 is determined by the shape and the material of the particles. The vibration attenuator/damper 7 is fitted in the interior rear-view mirror 9 at the position where the maximum oscillation movement occurs.

The receptacle 8 may, for example, be adhesively bonded or screwed to the housing bottom 6. What is essential is that the oscillation attenuator/damper 7 is not displaced from the position where it is installed. Besides fabric, the receptacle 8 may, for example, also consist of paper, pulp, a plastic sheet and the like.

FIG. 2 shows an oscillation attenuator/damper 7 whose receptacle 8 consists of a solid housing. It may, for example, consist of paper, plastic, metal or rubber-elastic material. Rubber-elastic material has the advantage of minimising noise. The housing 8 is only partially filled with the granulate particles 9, so as not to impede the movement of the granulate particles 9 which is necessary for the oscillation attenuation or damping. The housing 8 may be configured differently, depending on the position where it is installed. It is possible to provide the housing 8 with at least one filler opening or top-up opening, so that the granulate particles 9 may be topped-up or removed from the housing 8 should the need arise. This makes it possible to check the oscillation response of the component directly at the position where it is installed and, as necessary, introduce additionally required granulate particles 9 into the housing 8 or remove them from the housing. The opening is reliably closed with an appropriately releasable closure. The granulate particles 9 may be designed according to the previous embodiment and consist of the very wide variety of materials as explained with reference to FIG. 1.

FIG. 3 shows an oscillation attenuator/damper 7 which is essentially designed in the same way as the embodiment according to FIG. 2. The difference is that the granulate particles 9 in the housing 8 lie in a viscous damping liquid 10. This preferably consists of oil which, on the one hand, reduces the friction between the granulate particles 9 but, on the other hand, increases the damping capacity. Instead of oil, it is also possible to use any other suitable viscous liquid 10. By using this liquid 10, in conjunction with the shape and/or material of the granulate particles 9, it is thus possible to tune the oscillation attenuator/damper 7 optimally to the specific case in question.

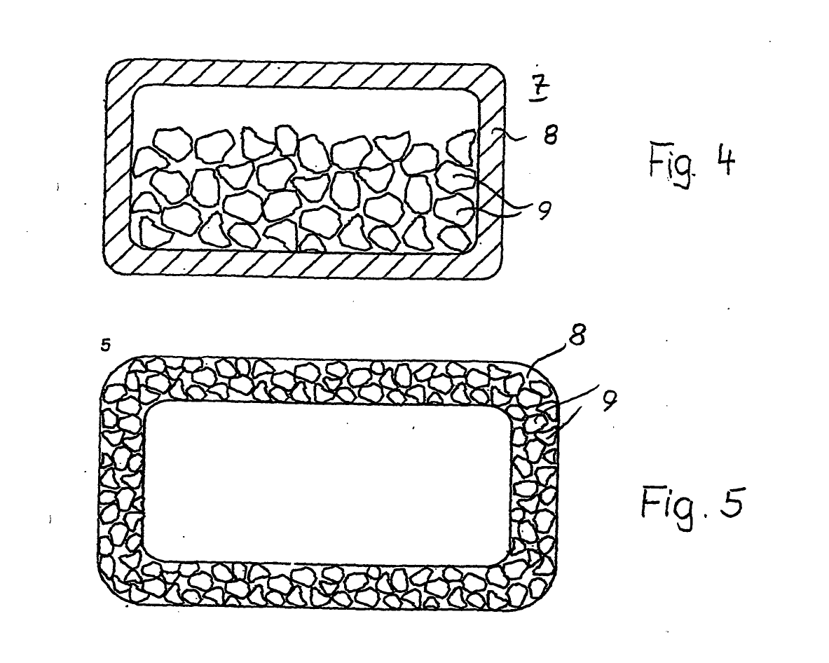

In the embodiment according to FIG. 4, the oscillation attenuator/damper 7 has a housing 8 made of an elastic material. The granulate particles 9 are held in the housing 8. Similarly to the embodiment according to FIG. 3, it is possible to introduce a viscous liquid into the housing 8.

The housing 8 consists of an oscillation- and/or noise-damping material, for example polyurethane or ethylene-propylene-diene copolymers. The elastic housing 8 is fastened to the part to be damped, for example the interior rear-view mirror 1. The described damping effect of the granulate particles 9 is then combined with the attenuating effect of the 1-mass oscillator of the housing 8. The attenuation frequency can be tuned or adjusted very accurately by means of the stiffness or elasticity of the housing 8 and the mass of the granulate particles 9.

FIG. 5 shows the possibility of accommodating the granulate particles 9 in the receptacle 8 designed as a housing frame. As was described with reference to FIG. 3, the granulate particles 9 may also lie in a viscous liquid.

The interior rear-view mirror 1 may have a housing 3 which, for example, is designed in the form of a hollow cavity corresponding to FIG. 5. It is also possible to design only parts of the housing 3 in the form of a frame, or to provide holding frames for the granulate particles 9 and/or the liquid 10 in the housing 3.

The described oscillation attenuators/dampers 7 may, for example, also be provided on exterior rear-view mirrors of motor vehicles. These exterior mirrors can be folded into and away from the driving direction. In particular, it is possible to fold the mirror head of an exterior rear-view mirror back onto the vehicle in the driving direction, into a parking position. This adjustment may be motorised or may take place manually. The mirror head may have at least one light exit window in its housing through which, for example, the light from a flashing indicator light can emerge. The housing of the mirror head may, however, also have at least one light directed towards the ground with which, for example, the ground region next to the vehicle can be lit. An ambient light of this kind may also be provided in combination with the flashing indicator light in the mirror head of the exterior rear-view mirror. The mirror head may furthermore contain an electrical drive mechanism for adjusting the mirror glass, a transmitter of a door opening device or a garage opening device, electrical or electronic components, electrical and/or electronic modules, electronic instruments such as antennas, circuits for rain sensors, heating elements and the like. The mirror head may, for example, furthermore hold antennas and/or receivers of navigation systems, dead-angle sensors, temperature sensors and/or temperature displays, antennas for radio, telephone and the like, microphones, toll detection systems, cameras and the like. The described components may be fitted selectively in the mirror head of the exterior rear-view mirror or in any combination with one another. In this context, it is also possible to fit some of these components in the mirror base of the exterior rear-view mirror.

The elements described for the exterior rear-view mirror, which may be provided in the mirror head and/or mirror base of the exterior rear-view mirror, may of course also be arranged in the interior rear-view mirror.

For an interior rear-view mirror, for example, it is sufficient to use granulate particles 9 in an amount of from about 80 to 130 g in the oscillation attenuator/damper 7, in order to achieve optimum oscillation or vibration damping.

1-28. (canceled)

29. Oscillation attenuator, for use in a motor vehicle, having at least one attenuator element, said attenuator element being formed by granulate particles which are held in a container.

30. Oscillation attenuator according claim 29, wherein the granulate particles are arranged in the container so that they can move relative to one another.

31. Oscillation attenuator according to claim 29, wherein the granulate particles are comprised of the same material.

32. Oscillation attenuator according to claim 29, wherein the granulate particles further comprise at least two different materials.

33. Oscillation attenuator according to claim 29, wherein the granulate particles comprise steel.

34. Oscillation attenuator according to claim 29, wherein the granulate particles further comprise cast iron.

35. Oscillation attenuator according to claim 29, wherein the granulate particles further comprise a plastic material.

36. Oscillation attenuator of claim 35, wherein said plastic is selected from the group consisting of polymethyl methacrylate, styrene-butadlene copolymers and mixtures and blends thereof.

37. Oscillation attenuator according to claim 29, wherein said container is flexible.

38. Oscillation attenuator according to claim 37, wherein the container comprising of fabric, paper, plastic or mixtures thereof.

39. Oscillation attenuator according to claim 29, wherein the container is designed as a geometrically stable housing.

40. Oscillation attenuator according to claim 39, wherein the container further comprises a plastic.

41. Oscillation attenuator according to claim 39, wherein the container comprises paperboard.

42. Oscillation attenuator according to claim 39, wherein the container further comprises a metal material.

43. Oscillation attenuator according to claim 29, wherein the container is a housing which comprises an elastically deformable material.

44. Oscillation attenuator according to claim 29, wherein the container comprises a cavity in a housing.

45. Oscillation attenuator according to claim 29, wherein the housing is designed as a frame.

46. Oscillation attenuator according to claim 29, wherein the granulate particles lie in a viscous liquid.

47. Oscillation attenuator according to claim 37, wherein the viscous liquid is oil.

48. Oscillation attenuator according to claim 29, wherein the container is provided on an interior rear-view mirror of said motor vehicle.

49. Oscillation attenuator according to claim 48, wherein the container lies behind a mirror glass of the interior rear-view mirror.

50. Oscillation attenuator according to claim 48, wherein the container is arranged in the mirror housing.

51. Oscillation attenuator according to claim 29, wherein the container is provided on an exterior rear-view mirror of the motor vehicle.

52. Oscillation attenuator according to claim 51, wherein the container lies behind a mirror glass of the exterior rear-view mirror.

53. Oscillation attenuator according to claim 51, wherein the container is arranged in the mirror head of the exterior rear-view mirror.

54. Oscillation attenuator according to claim 29, wherein the container is provided in the vicinity of the maximum oscillation movement.

55. Oscillation attenuator according to claim 29, wherein the granulate particles have an angulated shape.

56. Oscillation attenuator according to claim 29, wherein the granulate particles have an round shape.

57. Oscillation attenuator according to claim 29, wherein the granulate particles have a cross-sectional width in the range of between about two and about six millimeters.
